(19) United States
(12) Patent Application Publication
(10) Pub. No.: US 2026/0172940 A1
(43) Pub. Date: Jun. 18, 2026

(54) HANDOVER FAILURE PROCESSING METHOD THROUGH PHYSICAL LAYER AND MAC LAYER INDICATION IN NEXT-GENERATION MOBILE COMMUNICATION SYSTEM

(71) Applicant: SAMSUNG ELECTRONICS CO., LTD., Suwon-si, Gyeonggi-do (KR)

(72) Inventors: June HWANG, Suwon-si (KR); Seungri JIN, Suwon-si (KR)

(21) Appl. No.: 19/126,605

(22) PCT Filed: Nov. 3, 2023
(86) PCT No.: PCT/KR2023/017462

§ 371 Date: May 1, 2025

(30) Foreign Application Priority Data
Nov. 3, 2022 (KR) 10-2022-0145230
Feb. 3, 2023 (KR) 10-2023-0015080

(51) Int. Cl. H04W 36/32; H04W 36/00

(52) U.S. Cl. CPC H04W 36/324; H04W 36/0077

(57) ABSTRACT

The present disclosure relates to an operation of a terminal in a mobile communication system. An operation method of a terminal in a mobile communication system according to an embodiment of the present disclosure may comprise the steps of: receiving, from a serving cell, a radio resource control (RRC) message including an L1/L2-triggered mobility (LTM) configuration; receiving, from the serving cell, a medium access control (MAC) control element (CE) indicating LTM handover; starting a timer and performing the LTM handover on the basis of the LTM configuration; and when the LTM handover is successful, stopping the timer.

### TECHNICAL FIELD

The disclosure relates to an operation of a terminal in a mobile communication system and, more specifically, to a method of defining failure at the time of handover and an operation performed by a terminal at the time of handover failure.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DISCLOSURE OF INVENTION

### Solution to Problem

An operation method of a terminal in a mobile communication system according to an embodiment of the disclosure may include receiving, from a serving cell, a radio resource control (RRC) message including an L1/L2-triggered mobility (LTM) configuration, receiving, from the serving cell, a medium access control (MAC) control element (CE) indicating an LTM handover, starting a timer and performing the LTM handover, based on the LTM configuration, and in case that the LTM handover is successful, stopping the timer.

### Advantageous Effects of Invention

Various embodiments of the disclosure can provide a device and a method capable of effectively providing services in a mobile communication system.

### BRIEF DESCRIPTION OF DRAWINGS

FIG. 1 illustrates a structure of a typical long term evolution (LTE) system.

FIG. 2 illustrates a radio protocol structure of a typical LTE system.

FIG. 3 illustrates a structure of a next-generation mobile communication system according to an embodiment of the disclosure.

FIG. 4 illustrates a radio protocol structure of a next-generation mobile communication system according to an embodiment of the disclosure.

FIG. 5 is a block diagram illustrating an internal structure of a UE according to an embodiment of the disclosure.

FIG. 6 is a block diagram illustrating a structure of a new radio (NR) base station according to an embodiment of the disclosure.

FIG. 7 is a flowchart illustrating an operation of a terminal, a centralized unit (CU), and a distributed unit (DU) for an L1/L2-triggered mobility (LTM) operation according to an embodiment of the disclosure.

### BEST MODE FOR CARRYING OUT THE INVENTION

An operation method of a terminal in a mobile communication system according to an embodiment of the disclosure may include receiving, from a serving cell, a radio resource control (RRC) message including an L1/L2-triggered mobility (LTM) configuration, receiving, from the serving cell, a medium access control (MAC) control element (CE) indicating an LTM handover, starting a timer and performing the LTM handover, based on the LTM configuration, and in case that the LTM handover is successful, stopping the timer.

A terminal in a mobile communication system according to an embodiment of the disclosure may include a communication unit and a controller operably connected to the communication unit, wherein the controller is configured to receive, from a serving cell, a radio resource control (RRC) message including an L1/L2-triggered mobility (LTM) configuration, receive, from the serving cell, a medium access control (MAC) control element (CE) indicating an LTM handover, start a timer and perform the LTM handover, based on the LTM configuration, and in case that the LTM handover is successful, stop the timer.

### Mode for the Invention

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, various embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station is not limited to the above examples. In the disclosure, a “downlink (DL)” refers to a radio link via which a base station transmits a signal to a terminal, and an “uplink (UL)” refers to a radio link via which a terminal transmits a signal to a base station.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IOT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3 5GS/NR (5th generation mobile communication standards).

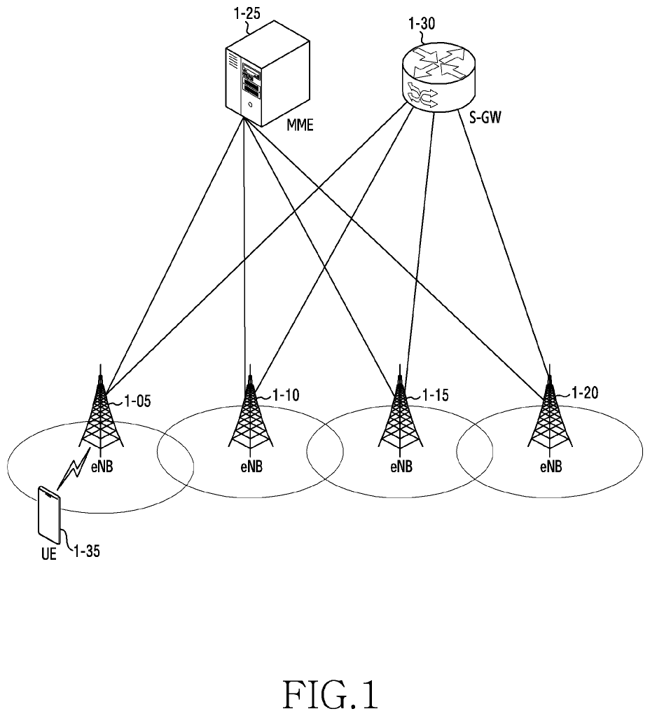

FIG. 1 illustrates a structure of a typical LTE system.

Referring to FIG. 1, as illustrated therein, a radio access network of an LTE system may include next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may correspond to conventional node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over IP (VOIP) via the Internet protocol, may be serviced through a shared channel. Thus, a device that collects state information, such as buffer states, available transmit power states, and channel states of UEs, and performs scheduling accordingly is required, and the ENBs 1-05 to 1-20 may serve as the device. In general, one eNB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

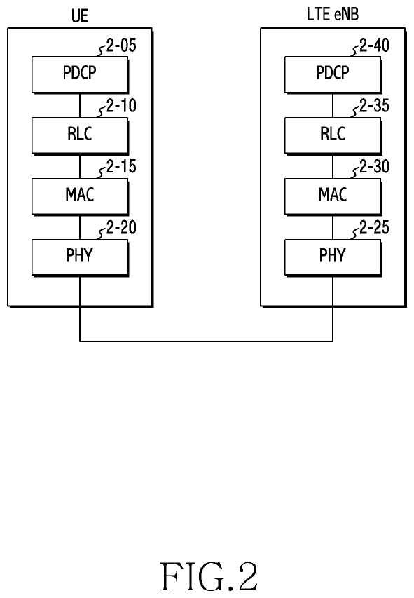

FIG. 2 illustrates a radio protocol structure of a typical LTE system.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and ENB sides. The PDCP may serve to perform operations such as IP header compression/reconstruction. The main functions of the PDCP may be summarized as follows. The PDCP is not limited by the following exemplary functions and may perform various functions.
Header compression and decompression: robust header compression (ROHC) only
Transfer of user data
In-sequence delivery (In-sequence delivery of upper layer PDUs at PDCP re-establishment procedure for RLC AM)
For split bearers in dual connectivity (DC) (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an automatic repeat request (ARQ) operation. The main functions of the RLC may be summarized as follows. The RLC is not limited by the following exemplary functions and may perform various functions.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows. The MAC is not limited by the following exemplary functions and may perform various functions.
Mapping between logical channels and transport channels
Multiplexing/demultiplexing of MAC SDUs belonging to one or different logical channels into/from transport blocks (TB) delivered to/from the physical layer on transport channels
Scheduling information reporting
HARQ (Error correction through HARQ)
Priority handling between logical channels of one UE
Priority handling between UEs by means of dynamic scheduling
Multimedia broadcast and multicast service (MBMS) service identification
Transport format selection
Padding

A physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The physical layer is not limited by these exemplary functions and may perform various functions.

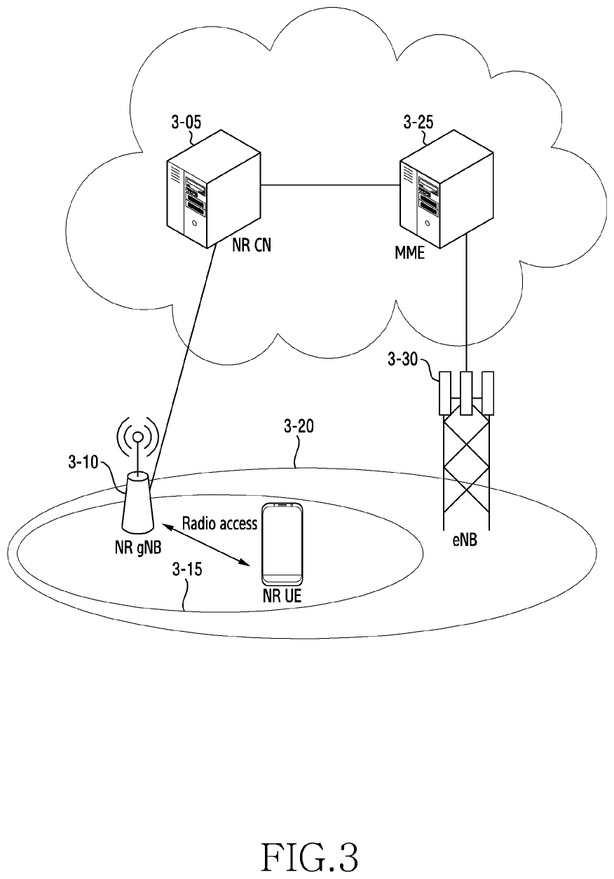

FIG. 3 illustrates a structure of a next-generation mobile communication system according to an embodiment of the disclosure.

Referring to FIG. 3, a radio access network of a next-generation mobile communication system (hereinafter NR or 5G) may include a new radio node B (hereinafter NR gNB or NR base station) 3-10, and a new radio core network (NR CN) 3-05. A new radio user equipment (NR UE or NR terminal) 3-15 may access an external network via the NR gNB 3-10 and the NR CN 3-05.

In FIG. 3, the NR gNB 3-10 may correspond to an evolved node B (eNB) of a conventional LTE system. The NR gNB may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR NB 3-10 may serve as the device. In general, one NR gNB may control multiple cells. In order to implement ultrahigh-speed data transfer beyond the current LTE, the next-generation mobile communication system may employ a wider bandwidth than the existing maximum bandwidth. in addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 3-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN 3-05 may be connected to an MME 3-25 via a network interface. The MME may be connected to an eNB 3-30 that is an existing base station.

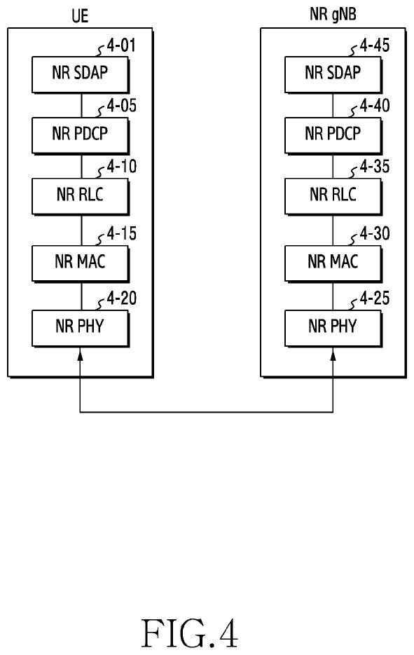

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 on each of UE and NR base station sides.

The main functions of the NR SDAP 4-01 or 4-45 may include some of functions below. The NR SDAP is not limited by the following exemplary functions and may perform various functions.
Transfer of user plane data
Mapping between a QoS flow and a data bearer for uplink and downlink (mapping between a QoS flow and a DRB for both DL and UL)
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QOS) reflection configuration 1-bit indicator (NAS reflective QoS) of the SDAP header and the access stratum (AS) QOS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below. The NR PDCP is not limited by the following exemplary functions and may perform various functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device may refer to a function of reordering PDCP PDUs received from a lower layer in an order based on PDCP sequence numbers (SNs). The reordering of the NR PDCP device may include a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

The main functions of the NR RLC 4-10 or 4-35 may include some of functions below. The NR RLC is not limited by the following exemplary functions and may perform various functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of successively delivering RLC SDUs received from the lower layer to the upper layer. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

The in-sequence delivery of the NR RLC device may refer to a function of, if there is a lost RLC PDU, delivering only RLC SDUs before the lost RLC PDU to the upper layer in sequence.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to now, to the upper layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include a concatenation function, but the concatenation function may be performed in the NR MAC layer or replaced with a multiplexing function of the NR MAC layer.

The out-of-sequence delivery of the NR RLC device 1035 or 1060 may refer to a function of directly delivering RLC SDUs, received from the lower layer, to the upper layer regardless of the sequence. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 14-15 or 4-30 may be connected to multiple NR RLC layer devices configured in one UE, and the main functions of the NR MAC may include some of functions below. The NR MAC is not limited by the following exemplary functions and may perform various functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR physical (PHY) layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The NR PHY layer is not limited by these exemplary functions and may perform various functions.

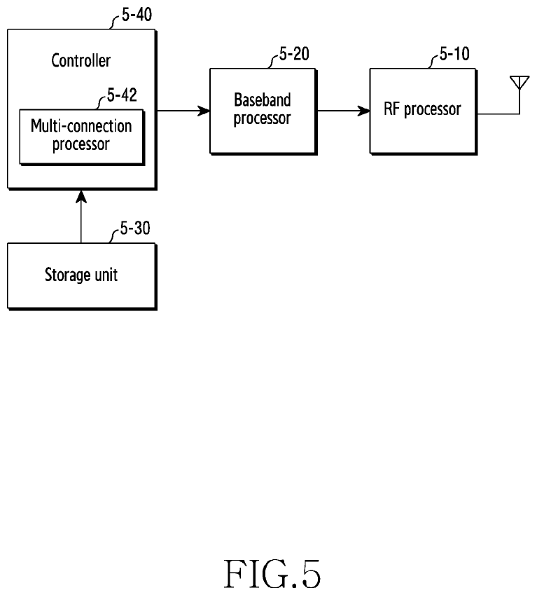

FIG. 5 is a block diagram illustrating an internal structure of a UE according to an embodiment of the disclosure.

Referring to FIG. 5, the UE may include a radio frequency (RF) processor 5-10, a baseband processor 5-20, a storage unit 5-30, and a controller 5-40.

The RF processor 5-10 may perform a function for transmitting and receiving a signal via a wireless channel, such as band conversion and amplification of the signal. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in FIG. 5, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of each of signals transmitted and received through multiple antennas or antenna elements. In addition, the RF processor 5-10 may perform multiple input multiple output (MIMO), and may receive multiple layers when performing MIMO operations.

The baseband processor 5-20 may perform functions of conversion between baseband signals and bitstrings according to the system's physical layer specifications. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the orthogonal frequency division multiplexing (OFDM) scheme, during data transmission, the baseband processor 5-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

The baseband processor 5-20 and the RF processor 5-10 may transmit and receive signals as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands. The UE may transmit/receive signals to/from the base station by using the baseband processor 5-20 and the RF processor 5-10. The signals may include control information and data.

The storage 5-30 stores data such as basic programs, application programs, and configuration information for operations of the UE. Particularly, the storage unit 5-30 may store information regarding a second access node configured to perform wireless communication by using a second radio access technology. In addition, the storage unit 5-30 provides the stored data at the request of the controller 240.

The controller 5-40 controls the overall operation of the UE. For example, the controller 5-40 may transmit/receive signals through the baseband processor 5-20 and the RF processor 5-10. In addition, the controller 5-40 records data in the storage unit 5-30 and reads the data from the storage unit 5-30. To this end, the controller 5-40 may include at least one processor. For example, the controller 5-40 may include a communication processor (CP) configured to perform control for communication, and an application processor (AP) configured to control upper layers such as application programs.

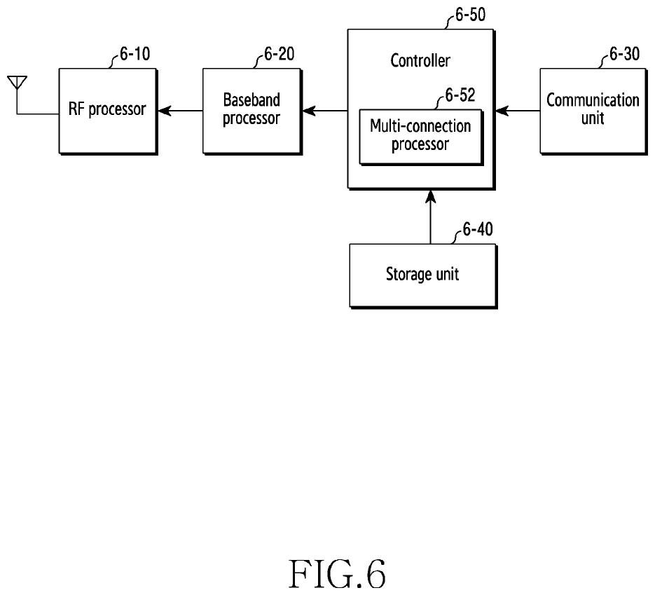

FIG. 6 is a block diagram illustrating the configuration of a new radio (NR) base station according to an embodiment of the disclosure.

Referring to FIG. 6, the base station may include an RF processor 6-10, a baseband processor 6-20, a backhaul communication unit 6-30, a storage unit 6-40, and a controller 6-50.

The RF processor 6-10 may perform a function for transmitting and receiving a signal via a wireless channel, such as band conversion and amplification of the signal. That is, the RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in FIG. 6, the base station may include multiple antennas. In addition, the RF processor 6-10 may include multiple RF chains. Furthermore, the RF processor 6-10 may perform beamforming. For the beamforming, the RF processor 6-10 may adjust the phase and magnitude of each of signals transmitted and received through multiple antennas or antenna elements. The RF processor may transmit one or more layers to perform a downward MIMO operation.

The baseband processor 6-20 may perform functions of conversion between baseband signals and bitstrings according to the physical layer specifications of first radio access technology. For example, during data transmission, the baseband processor 6-20 may encode and modulate a transmitted bitstring to generate complex symbols. In addition, during data reception, the baseband processing unit 6-20 may demodulate and decode a baseband signal provided from the RF processing unit 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, on receiving data, the baseband processor 6-20 may divide the baseband signal provided from the RF processor 6-10 into units of OFDM symbols, restore signals mapped to subcarriers via the FFT operation, and then restore a received bit stream via demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, a communication unit, or a wireless communication unit. The base station may transmit/receive signals to/from the UE by using the baseband processor 6-20 and the RF processor 6-10. The signals may include control information and data.

The backhaul communication unit 6-30 may provide an interface for communicating with other nodes in the network. That is, the backhaul communication unit 6-30 may convert bitstrings transmitted from the main base station to other nodes (for example, auxiliary base station, core network) to physical signals, and may convert physical signals received from the other nodes to bitstrings.

The storage unit 6-40 stores data such as basic programs, application programs, and configuration information for operations of the base station. In particular, the storage 6-40 may store information on bearers allocated to the connected UE, measurement results reported from the connected UE, and the like. In addition, the storage unit 6-40 may store information serving as a reference to determine whether to provide multi-connection to a UE or to suspend the same. In addition, the storage unit 6-40 provides stored data at the request of the controller 6-50.

The controller 6-50 controls the overall operation of the base station. For example, the controller 6-50 may transmit/receive signals through the baseband processor 6-20 and the RF processor 6-10 or through the backhaul communication unit 6-30. In addition, the controller 6-50 records data in the storage unit 6-40 and reads the data from the storage unit 6-40. To this end, the controller 6-50 may include at least one processor.

In case of handover indicated by a physical layer or MAC layer, failure of the handover needs to be defined. In an embodiment of the disclosure, a timer is introduced and a condition where the timer starts/a condition where the timer stops may be configured. When the timer expires, handover failure is considered and a processing operation is performed.

According to an embodiment of the disclosure, handover failure may be recognized by a network and a UE may transition to an operable state again.

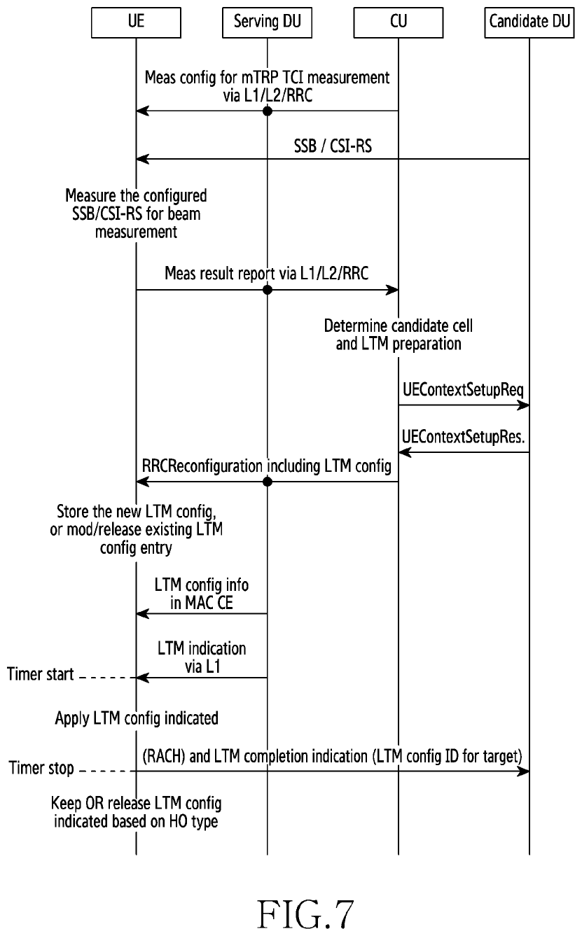

FIG. 7 is a flowchart illustrating an operation of a UE, a centralized unit (CU), and a distributed unit (DU) for an L1/L2-triggered mobility (LTM) operation according to an embodiment of the disclosure.

Referring to FIG. 7, a CU may transfer, to a UE through a serving cell, pieces of information for measurement of beams to be measured among beams of neighboring cells, in particular, neighboring cells operated by a DU under the same CU. The information may be transferred together with time information or a condition to transmit a result of measurement. The beam information may be given as TCI state information. In addition, the information may be included and transferred in DCI or a DL MAC CE. The UE having received the information may measure a configured beam of a corresponding neighboring cell. The UE may report a result of the measurement when a given condition is triggered, and/or at a particular period. The CU having received a corresponding report may request an L1/L2-triggered mobility (LTM) configuration for particular cells operated by a DU controlled by the CU, and request configuration information therefor from the DU. The DU may transfer configuration information for LTM related to a corresponding target cell to the CU again. The CU may assign a particular ID to the configuration information in units of RRCReconfiguration, CellGroupconfiguration, or cell configuration and transfer the particular ID to the UE in associated with configuration information. The CU may transfer same in a form of a list. In this case, a message used may be an RRCReconfiguration message. The UE having received the list may store LTM configuration information in which the list is included in a variable for LTM. Thereafter, when a signal/message indicating execution of LTM to a particular LTM target cell is received from a network, the UE may apply an LTM configuration associated with the target cell and indicate completion of HO and/or application to the target cell. When the network (e.g., base station) transmits a signal indicating execution of LTM, the network may first transmits an ID list of available target cells through a MAC CE to enable the UE to perform a particular operation and may use DCI to actually indicate execution of LTM to a particular target cell. In this case, the UE may, for example, first perform DL synchronization or perform RA with respect to target cells notified by the network through a MAC CE in advance. An indication indicating LTM execution through DCI may include a single particular LTM ID, and the UE may perform handover to a cell corresponding to the ID. In another embodiment, a particular ID may be indicated only through a MAC CE regardless of DCI thereby indicating execution of LTM. What indicates successful execution of handover may be a UL RRC message, or may be a UL MAC CE or UCI.

After a successful LTM HO is performed, the UE may maintain a pre-configured LTM configuration without erasing same.

In an embodiment, if a configuration of a target cell of LTM corresponds to RRCReconfiguation, that is, if, when the UE receives an LTM configuration of the UE from the network (e.g., base station), a configuration to be applied to each target cell at the time of HO is an RRCReconfiguration message and, when a LTM execution indication is received, the UE applies a RRCReconfiguration message corresponding to a corresponding indicated LTM ID, a timer use indicator and a timer value may be included in the RRCReconfiguration message corresponding to the LTM ID and transferred to the UE.

If an LMT configuration is included in an RRCReconfiguration message, a timer value and/or a timer use indicator may be included and transferred by a target CU in reconfigWithSync of spcellconfig included in the RRCReconfiguration message, and such an RRCReconfiguration message may be included and transferred in an LTM configuration container of outer RRCReconfig.

### Timer Operation:

Timer start: When LTM is triggered (i.e., when applying RRCReconfig including reconfig WithSync in LTM configuration triggered(indicated) by the serving cell) or when a MAC CE or DCI for triggering LTM is received
Timer stop: When RACH to an LTM target cell is successful, or when an RRCReconfigurationComplete message is successfully transmitted to an LTM target cell (a RACH skip is indicated in an RRCReconfig message) In an embodiment, if a configuration of a target cell of LTM corresponds to CellGroupConfig, that is, if, when the UE receives an LTM configuration of the UE from the network (e.g., base station), a configuration to be applied to each target cell at the time of LTM HO is CellGroupConfig or an RRCReconfiguration message (CellGroupConfig and a common configuration are transferred together as a transferred configuration) and, when a LTM execution indication is received, the UE applies a CellGroupConfig/RRCReconfiguration message corresponding to a corresponding indicated LTM ID,
Configuration: In a case of CellGroupConfig, a target CU (the same CU as a source in a case of LTM) includes and transfers a timer value/timer use indicator in reconfigWithSync of specellConfig in CellGroupConfig in an LTM config field of outer RRCReconfig, and/or introduces and transfers a separate timer in LTM config (same is applicable to MAC spec).

### Operation:

Start: Operation starts when LTM is triggered (when applying CellGroupConfig in LTM configuration Triggered (indicated) by the serving cell) or when a MAC CE or DCI for triggering LTM is received (same is applied to MAC spec or R1 spec)
Stop: When RACH to an LTM target cell is successful, or when an LTM completion indication is successfully transmitted to an LTM target cell through an RRC UL message/a UL MAC CE/UCI (same may be applied when a RACH skip is indicated) If an indicator indicating RACH omission may be included in a reconfigWithSync field of specellConfig of CellGroupConfig or a position in spcellconfig. In this case, timing advance information and configuration information of a UL grant which are to be used at a target cell may be included and transferred to the UE. In a case where the indicator is included, the UE may need to, when performing LTM, apply an indicated target cell configuration and then transmit RRC/MAC CE/UCI including a completion indication to the target cell. In this case, without a separate random access procedure, the UE may apply a given timing advance (TA) and use given configuration information of a UL grant to transfer a completion message/signal to the target cell. The UL grant configuration information is frequency information and time information of a UL resource, and the time information may be configured by a period value of a repeated UL grant, an indicator in units of a particular SFN or subframe/slot, and an offset value indicating an available position at a specific time from the indicator.

Additionally, in a case of RACH execution based on configuration information to be used at the time of a handover, the configuration information may include an indicator indicating execution of CFRA and CBRA and random access configuration information available therefor. The random access configuration information may include a RA preamble ID or preamble indication information, or time or frequency information of an occasion for RA. When the UE receives such an indication, the UE may perform RA to a target cell when performing LTM. In this case, a completion message transferred when LTM is completed may be transferred using a TA value and UL grant information obtained in an RA process.

In an embodiment, a candidate target cell configuration may correspond to one value of cell config.
Configuration: In a case of cell config, a target CU (in a case of LTM, the same CU) includes and transfers a timer value/timer use indicator in reconfigWithSync of spcellConfig in an LTM config field of outer RRCReconfig, or introduces and transfers a separate timer in LTM config
Operation
Start: Operation starts when LTM is triggered (when applying cellconfig (or spcellConfig) in LTMconfiguration triggered (indicated) by the serving cell) or when a MAC CE or DCI for triggering LTM is received (same is applied to MAC spec or R1 spec)
Stop: When RACH to an LTM target cell is successful or when an LTM completion indication is successfully transmitted to an LTM target cell through an RRC UL message/a UL MAC CE/UCI (when a RACH skip is indicated) If an indicator indicating RACH omission may be included in a reconfigWithSync field of specellConfig of CellGroupConfig or a position in spcellconfig. In this case, timing advance information and configuration information of a UL grant which are to be used at a target cell may be included and transferred to the UE. In a case where the indicator is included, the UE may need to, when performing LTM, apply an indicated target cell configuration and then transmit RRC/MAC CE/UCI including a completion indication to the target cell. In this case, without a separate random access procedure, the UE may apply a given timing advance (TA) and use given configuration information of a UL grant to transfer a completion message/signal to the target cell. The UL grant configuration information is frequency information and time information of a UL resource, and the time information may be configured by a period value of a repeated UL grant, an indicator in units of a particular SFN or subframe/slot, and an offset value indicating an available position at a specific time from the indicator.

Additionally, in a case of RACH execution based on configuration information to be used at the time of a handover, the configuration information may include an indicator indicating execution of CFRA and CBRA and random access configuration information available therefor. The random access configuration information may include a RA preamble ID or preamble indication information, or time or frequency information of an occasion for RA. When the UE receives such an indication, the UE may perform RA to a target cell when performing LTM. In this case, a completion message transferred when LTM is completed may be transferred using a TA value and UL grant information obtained in an RA process.

In an embodiment, in a case not corresponding to the above embodiments, that is, unlike an existing method of transferring a value for each target cell, a separate timer for an LTM operation may be introduced.

The purpose of LTM is to minimize intervention of RRC so as to reduce an interruption time. Therefore, a CU may indicate use of a common timer and configure a single value. Such a single value may be included and transferred in an LTM container. In addition, the same value for all candidate cells may be used.
Configuration: A single timer use indicator and/or timer value may be separately indicated in an LTM container regardless of whether a configuration of a candidate target cell is RRCReconfiguration, Cell Group Config, or Cell Configuration (or spcell Config).
Operation: A condition of start and stop operations of a timer may be configured and operated identically to start and stop conditions defined in the above embodiments.

In an embodiment, failure may be defined as follows.
If a failure-related timer expires, failure may be considered.

In an embodiment, as a processing operation at the time of failure, the UE may perform at least one of the following operations.
The UE may maintain LTM configuration information before LTM execution.
The UE may use configuration information before LTM execution to select a source cell before LTM execution and access the source cell.
The UE may, instead of accessing a source cell, perform a normal cell selection operation in an RRC reestablishment operation to select a cell and access the cell.
If the selected cell is a candidate cell associated with a configuration of a conditional handover or LTM stored in the UE, the UE may access the cell by applying the configuration of the conditional handover or LTM.
After accessing the above cells, the UE may indicate LTM execution failure to the base station. This indication may be transferred to the accessed cell through a UL MAC CE or DCI.
In this case, a failed LTM configuration ID or failed cell ID at the time of LTM execution and/or an indicator indicating LTM execution failure may be transferred through an RRC message.
If timer configuration and start/stop operations are performed at a MAC/PHY layer, the MAC/PHY layer may transfer a timer expiry or LTM failure indicator to an RRC layer when the timer expires.
The network may indicate execution of the operations, that is, an operation of reporting LTM execution failure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

1. An operation method of a terminal in a mobile communication system, the method comprising:
receiving, from a serving cell, a radio resource control (RRC) message including an L1/L2-triggered mobility (LTM) configuration;
receiving, from the serving cell, a medium access control (MAC) control element (CE) indicating an LTM handover;
starting a timer and performing the LTM handover, based on the LTM configuration; and
in case that the LTM handover is successful, stopping the timer.

2. The method of claim 1, wherein, in case that a random access channel (RACH) procedure with a target cell is successful, the LTM handover is determined to be successful.

3. The method of claim 1, further comprising, in case that the timer expires, determining that the LTM handover is unsuccessful.

4. The method of claim 3, further comprising performing an RRC reestablishment procedure for cell selection.

5. The method of claim 4, further comprising, in case that the LTM configuration comprises information related to a cell selected in the RRC reestablishment procedure, accessing the selected cell, based on the LTM configuration.

6. The method of claim 1, wherein the timer is a timer related to an RRC layer.

7. The method of claim 1, wherein the RRC message comprises a timer use indicator and a timer value.

8. A terminal in a mobile communication system, the terminal comprising:
a communication unit; and
a controller operably connected to the communication unit, wherein the controller is configured to:
receive, from a serving cell, a radio resource control (RRC) message including an L1/L2-triggered mobility (LTM) configuration;
receive, from the serving cell, a medium access control (MAC) control element (CE) indicating an LTM handover;
start a timer and perform the LTM handover, based on the LTM configuration; and
in case that the LTM handover is successful, stop the timer.

9. The terminal of claim 8, wherein the controller is configured to, in case that a random access channel (RACH) procedure with a target cell is successful, determine that the LTM handover is successful.

10. The terminal of claim 8, wherein the controller is configured to, in case that the timer expires, determine that the LTM handover is unsuccessful.

11. The terminal of claim 10, wherein the controller is configured to perform an RRC reestablishment procedure for cell selection.

12. The terminal of claim 11, wherein the controller is configured to, in case that the LTM configuration comprises information related to a cell selected in the RRC reestablishment procedure, access the selected cell, based on the LTM configuration.

13. The terminal of claim 8, wherein the timer is a timer related to an RRC layer.

14. The terminal of claim 8, wherein the RRC message comprises a timer use indicator and a timer value.
